(19) United States
(12) Patent Application Publication
(10) Pub. No.: US 2015/0161556 A1
(43) Pub. Date: Jun. 11, 2015

(54) OPTIMIZATION OF SHIPMENT CONTAINERIZATION FOR MULTICHANNEL FULFILLMENT CENTERS

(71) Applicant: Prasanna Jena, Cupertino, CA (US)

(72) Inventor: Prasanna Jena, Cupertino, CA (US)

(73) Assignee: EBAY INC., SAN JOSE, CA (US)

(21) Appl. No.: 14/102,689

(22) Filed: Dec. 11, 2013

(51) Int. Cl. G06Q 10/08; G06Q 30/02

(52) U.S. Cl. CPC G06Q 10/083; G06Q 30/0222

(57) ABSTRACT

A system and method for optimizing shipment of containers between fulfillment centers are described. The system identifies a buyer fulfillment center associated with a region of a delivery address of a buyer of an item listed in an online marketplace. The item is physically held at a seller fulfillment center. The system identifies a container having a prescheduled shipping route from the seller fulfillment center to the buyer fulfillment center. Space availability in the container is determined when the buyer views the item in the online marketplace. The system determines whether the container can receive the item based on an identification of the item and the space availability of the container and computes a shipping discount offer based on the space availability of the container. The buyer is notified of the shipping discount offer valid for a limited amount of time after the buyer views the item in the online marketplace. The limited amount of time is computed based on the space availability of the container and a cut off shipping time of the prescheduled shipping route of the container.

### TECHNICAL FIELD

This application relates generally to the field of computer technology and, in a specific example embodiment, to a method and system for optimizing shipment of containers between fulfillment centers.

### BACKGROUND

Online and offline marketplaces include many sellers listing items for sale. Buyers buy these items and sellers ship the items to the buyer upon receipt of payment. Many buyers and sellers are located across the country or across many geographical regions. Shipping cost increases with the number of items being shipped separately to multiple shipping destinations, further contributing to cardboard and fuel waste.

### BRIEF DESCRIPTION OF THE DRAWINGS

The present disclosure is illustrated by way of example, and not by way of limitation, in the figures of the accompanying drawings in which:

FIG. 1 is a network diagram depicting a network system having a client-server architecture configured for exchanging data over a network, according to one embodiment.

FIG. 2 shows a block diagram illustrating one example embodiment of a marketplace application.

FIG. 3 shows a block diagram illustrating one example embodiment of a shipment containerization application.

FIG. 4 shows a map diagram illustrating one example embodiment of a shipment using the shipment containerization application.

FIG. 5 shows a flow diagram illustrating one example embodiment of an operation of a shipment containerization application.

FIG. 6 shows a flow diagram illustrating one example embodiment of a method for determining shipping discount based on space availability of a container.

FIG. 7 shows a flow diagram illustrating one example embodiment of a method for determining a length of the limited time offer based on the number of discount offers pending.

FIG. 8 shows a ladder diagram illustrating one example embodiment of an operation of a shipment containerization application.

FIG. 9 shows a diagrammatic representation of machine, in the example form of a computer system, within which a set of instructions may be executed to cause the machine to perform any one or more of the methodologies discussed herein.

### DETAILED DESCRIPTION

Although the present disclosure is described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

A system and method for optimizing shipment of containers between fulfillment centers are described. The system identifies a buyer fulfillment center associated with a region of a delivery address of a buyer of an item listed in an online marketplace. The item is physically held at a seller fulfillment center. The system identifies a container having a prescheduled shipping route from the seller fulfillment center to the buyer fulfillment center. Space availability in the container is determined when the buyer views the item in the online marketplace. The system determines whether the container can receive the item based on an identification of the item and the space availability of the container and computes a shipping discount offer based on the space availability of the container. The buyer is notified of the shipping discount offer valid for a limited amount of time after the buyer views the item in the online marketplace. The limited amount of time is computed based on the space availability of the container and a cut off shipping time of the prescheduled shipping route of the container.

In one embodiment, physical dimensions of a package for the item are determined based on historical data of the online marketplace. The system determines whether the package can fit in the container based on the physical dimensions of the package and the space availability of the container.

In another embodiment, the system determines whether the item qualifies for shipping with the container based on the physical dimensions of the item retrieved from the historical data of the online marketplace before calculating the shipping discount offer.

In another embodiment, the container physically houses a plurality of items ordered on the online marketplace. The plurality of items are held at the seller fulfillment center and scheduled to be shipped to the same region of the delivery address of the buyer of the item.

In another embodiment, the amount of the shipping discount offer decreases as the space availability of the container decreases, and the limited amount of time decreases as the space availability of the container decreases.

In another embodiment, the system temporarily reduces the space availability of the container based on a size of the item during the limited amount of time after the shipping discount offer is provided to the buyer. The system receives a communication from the buyer accepting the shipping discount offer within the limited amount of time after the shipping discount offer is provided to the buyer. The system then permanently reduces the space availability of the container based on the size of the item in response to receiving the communication from the buyer accepting the shipping discount offer within the limited amount of time after the shipping discount offer is provided to the buyer.

In another embodiment, the system temporarily reduces the space availability of the container based on a size of the item during the limited amount of time after the shipping discount offer is provided to the buyer. The system receives a communication from the buyer declining the shipping discount offer within the limited amount of time after the shipping discount offer is provided to the buyer. The system then increases the space availability of the container in response to receiving the communication from the buyer declining the shipping discount offer within the limited amount of time after the shipping discount offer is provided to the buyer.

In another embodiment, the system temporarily reduces the space availability of the container based on a size of the item during the limited amount of time after the shipping discount offer is provided to the buyer and increases the space availability of the container after the limited amount of time has elapsed.

In another embodiment, the system dynamically updates the space availability of the container based on other shipping discount offers provided to other buyers of items associated with the same buyer fulfillment center and seller fulfillment center.

In another embodiment, the system computes a second shipping discount offer based on the space availability of a second container being shipped to the seller fulfillment center for the buyer fulfillment center at a time after the container has shipped. The system then provides the second shipping discount offer to the buyer for a second limited time, the second limited time computed based on the space availability of the second container and after the cut off shipping time of the container and before the cut off shipping time of the second container.

### System Architecture

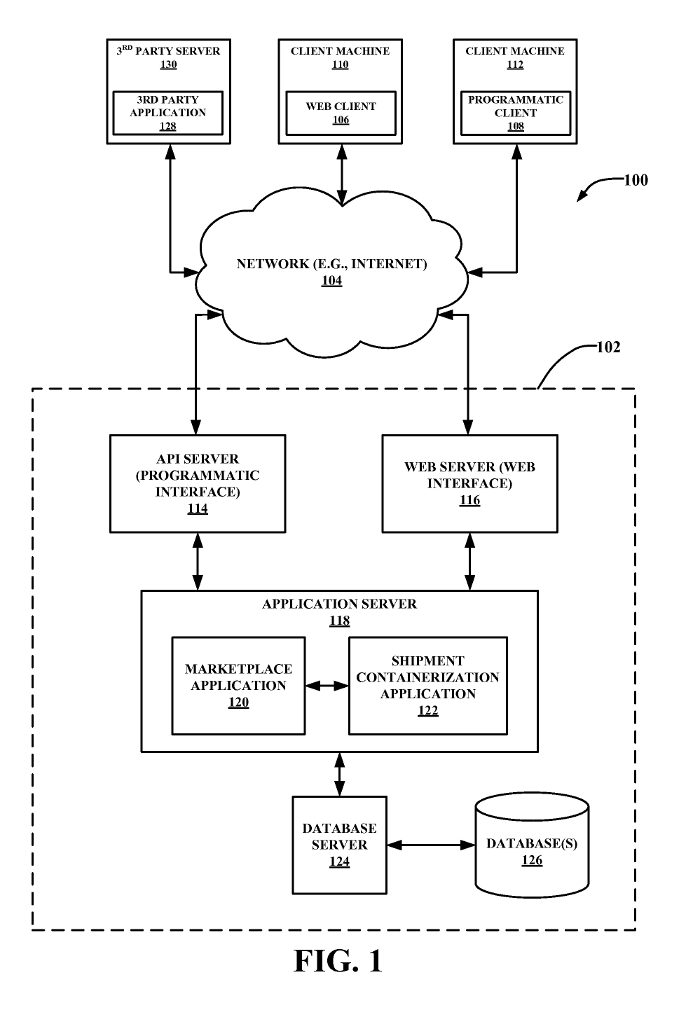

FIG. 1 is a network diagram depicting a network system 100 having a client-server architecture configured for exchanging data over a network, according to one embodiment. For example, the network system 100 may be a publication/publisher system where clients may communicate and exchange data within the network system 100. The data may pertain to various functions (e.g., online item purchases) and aspects (e.g., managing content and user reputation values) associated with the network system 100 and its users. Although illustrated herein as a client-server architecture, other embodiments may include other network architectures, such as peer-to-peer or distributed network environments.

A data exchange platform, in an example form of a marketplace application 120 and a shipment containerization application 122, may provide server-side functionality, via a network 104 (e.g., the Internet) to one or more clients. The one or more clients may include users that utilize the network system 100 and, more specifically, the marketplace application 120 and a shipment containerization application 122, to exchange data over the network 104. These transactions may include transmitting, receiving (communicating), and processing data to, from, and regarding content and users of the network system 100. The data may include, but is not limited to, content and user data such as user profiles; user attributes; product and service reviews and information, such as pricing and descriptive information; product, service, manufacturer, and vendor recommendations and identifiers; product and service listings associated with buyers and sellers; auction bids; and transaction data, such as collection and payment, shipping transactions, shipping label purchases, and real time synchronization of financial journals, among others.

In various embodiments, the data exchanges within the network system 100 may be dependent upon user-selected functions available through one or more client or user interfaces (UIs). The UIs may be associated with a client machine, such as a client machine 110 using a web client 106. The web client 106 may be in communication with the marketplace application 120 via a web server 116. The UIs may also be associated with a client machine 112 using a programmatic client 108, such as a client application, or a third party server 130 with a third party application 128. It can be appreciated that in various embodiments, the client machines 110, 112, or third party server 130 may be associated with a buyer, a seller, a third party electronic commerce platform, a payment service provider, a shipping service provider, or a financial institution system, each in communication with the networked system 102 and optionally each other. The buyers and sellers may be any one of individuals, merchants, or service providers.

Turning specifically to the marketplace application 120 and the shipment containerization application 122, an application program interface (API) server 114 and a web server 116 are coupled to, and provide programmatic and web interfaces respectively to, one or more application servers 118. The application server 118 hosts one or more marketplace applications 120 and shipment containerization application 122. The application server 118 is, in turn, shown to be coupled to one or more database servers 124 that facilitate access to one or more databases 126.

In one embodiment, the web server 116 and the API server 114 communicate and receive data pertaining to listings and transactions, among other things, via various user input tools. For example, the web server 116 may send and receive data to and from a toolbar or webpage on a browser application (e.g., web client 106) operating on a client machine (e.g., client machine 110). The API server 114 may send and receive data to and from an application (e.g., programmatic client 108 or third party application 128) running on another client machine (e.g., client machine 112 or third party server 130).

In one embodiment, the marketplace application 120 provides listings and price-setting mechanisms whereby a user may be a seller or buyer who lists or buys goods and/or services (e.g., for sale) published on the marketplace application 120.

In one embodiment, the shipment containerization application 122 includes a system and a method for optimization shipment of containers between fulfillment centers.

For example, warehouses or fulfillment centers may include physical facilities located throughout one or more countries configured to hold inventory for sellers. In other words, a seller may ship an item for sale on the marketplace application 120 to a closest fulfillment center of the seller. Once the item is sold using the marketplace application 120, the order is fulfilled by shipping the item from the fulfillment center to the delivery address of a buyer of the item. As such, the shipment containerization application 122 may keep track of the inventory of items in the network of the fulfillment centers. Furthermore, additional data may be mined from the historical data of the marketplace application 120 to determine item details such as item descriptions, dimensions, weights, shipping services most often used or associated with, cost of service and estimated delivery time.

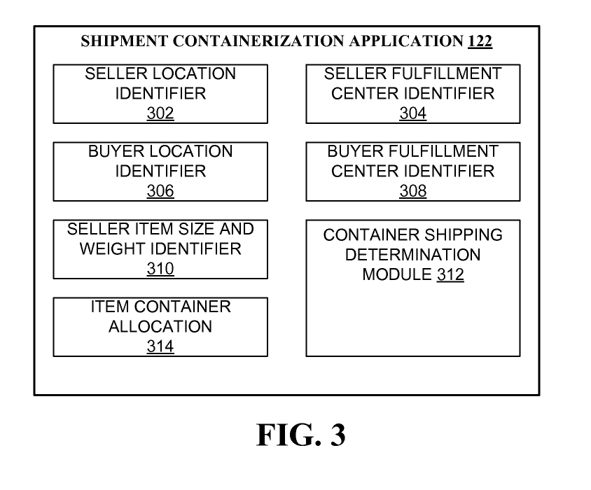

The shipment containerization application 122 can consolidate shipment of items from one fulfillment center to another fulfillment center so that the shipping cost per package can be reduced as a result of the consolidation or combining shipments in a container. The container may include, for example, a pallet or a carton that can house multiple shipments, packages, or items. If the shipment of the item viewed by a buyer can be consolidated in a container, the shipment containerization application 122 can offer the user a shipping discount valid for a limited time. The shipment containerization application 122 is described in more detail below with respect to FIG. 3.

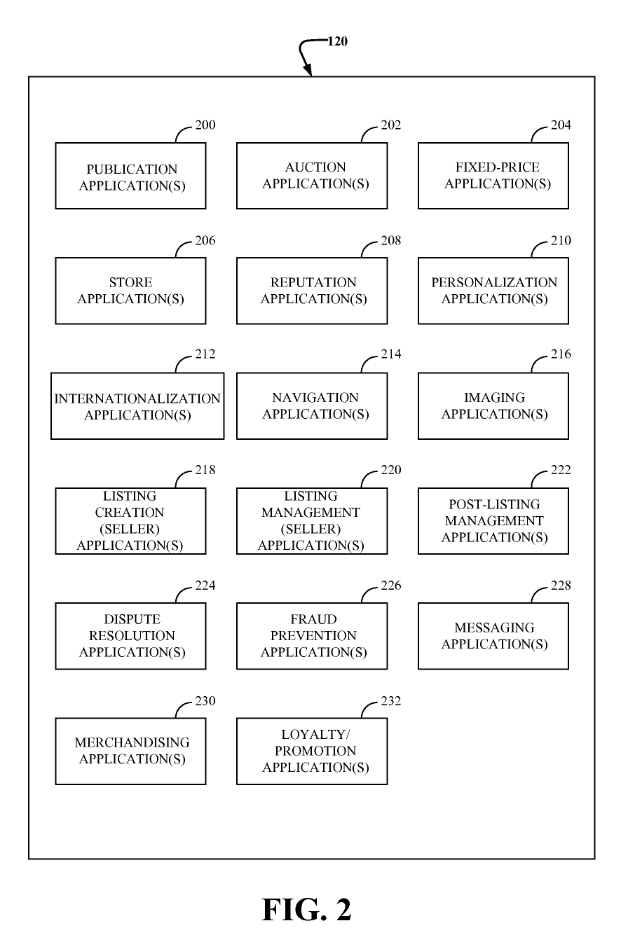

FIG. 2 shows a block diagram illustrating one example embodiment of the marketplace application 120. The marketplace application 120 may be hosted on dedicated or shared server machines (not shown) that are communicatively coupled to enable communications between server machines. The marketplace application 120 and the shipment containerization application 122 themselves are communicatively coupled (e.g., via appropriate interfaces) to each other and to various data sources, so as to allow information to be passed between the marketplace application 120 and the shipment containerization application 122 or so as to allow the marketplace application 120 and the shipment containerization application 122 to share and access common data. The marketplace application 120 and the shipment containerization application 122 may, furthermore, access one or more databases 126 via the database servers 124.

The networked system 102 may provide a number of publishing, listing, and price-setting mechanisms whereby a seller may list (or publish information concerning) goods or services for sale; a buyer can express interest in or indicate a desire to purchase such goods or services; and a price can be set for a transaction pertaining to the goods or services. To this end, the marketplace application 120 is shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. For example, consider that where the networked system 102 supports person-to-person trading, users may have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page in which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may, accordingly, include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings available via the networked system 102 as visually informing and attractive as possible, the marketplace application 120 may include one or more imaging applications 216, which users may utilize to upload images for inclusion within the listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller to conveniently provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 (such as, for example, messages advising users regarding the status of listings at the networked system 102 (e.g., providing “outbid” notices to bidders during an auction process or to provide promotional and merchandising information to users)). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotion applications 232. For example, a buyer may earn loyalty or promotion points for each transaction established and/or concluded with a particular seller, and be offered a reward for which accumulated loyalty points can be redeemed.

FIG. 3 shows a block diagram illustrating one example embodiment of the shipment containerization application 122. The shipment containerization application 122 may include a seller location identifier 302, a seller fulfillment center identifier 304, a buyer location identifier 306, a buyer fulfillment center identifier 308, a seller item size and weight identifier 310, a container shipping determination module 312, and an item container allocation module 314.

The seller location identifier 302 identifies an address associated with the seller. For example, the address may be a residence address of the seller, work address of the seller, or any other address specified by the seller where the item is to be shipped from by the seller. The seller may include a user who listed an item for sale using the marketplace application 120. The term “seller” may also refer to a user who has sold or not yet sold a listed item for sale in the marketplace application 120. The seller location identifier 302 communicates with the marketplace application 120 to access address information of the seller.

The seller fulfillment center identifier 304 identifies a fulfillment center associated with a region of the address of the seller identified in the seller location identifier 302. The region may include a geographic region such as a zip code area, a county, a city, etc. In one embodiment, the seller fulfillment center identifier 304 identifies one or more fulfillment centers from a network of fulfillment centers of the marketplace application 120 closest to the address of the seller. The seller fulfillment center identifier 304 may then select a fulfillment center from the identified fulfillment centers closest to the seller based on the capacities of the fulfillment center. Capacities may include physical space, available space, strategic geographic area, manpower, ease of access to shipping carriers, etc. In one embodiment, the seller fulfillment center identifier 304 communicates, via the marketplace application 120, with the seller of the address of the selected fulfillment center for the seller to ship the item. The item is then held at the selected fulfillment center until an order from a seller for the item is received in the marketplace application 120.

The buyer location identifier 306 identifies an address associated with the buyer. The address may include the delivery address of where the buyer would like the item shipped. For example, the buyer may identify several addresses in the marketplace application 120 for delivery addresses (e.g., home, work, vacation home, etc.). The buyer may also identify a default shipping address. The buyer may include a user who views an item for sale using the marketplace application 120. The term “buyer” may also refer to a user who has purchased or not yet purchased the item in the marketplace application 120. For example, the user may be referred to as a buyer when the user views items for sale without placing a purchase order, places any item for sale in a virtual shopping cart or wish list, or submits an order for any item for sale. The buyer location identifier 306 communicates with the marketplace application 120 to access address information of the buyer. In another embodiment, the buyer location identifier 306 identifies a buyer geographic region associated with a shipping or delivery address of the buyer. For example, the buyer location identifier 306 identifies a county or a zip code associated with the delivery address of the buyer.

The buyer fulfillment center identifier 308 identifies one or more fulfillment centers corresponding to the buyer geographic region. For example, the buyer fulfillment center identifier 308 identifies one or more fulfillment centers closest to the buyer geographic region using a database or table of fulfillment centers and corresponding geographic regions and/or addresses. In one embodiment, the buyer fulfillment center identifier 308 selects a fulfillment center from the identified fulfillment centers based on parameters such as distance to the delivery address of the buyer, ease of access route (local road vs. highway) to the delivery address of the buyer, storage capacity of the fulfillment centers, ease of accessibility to shipping carriers, processing capacity of the fulfillment centers, etc. In one embodiment, the buyer fulfillment center identifier 308 communicates to the marketplace application 120 to have the item shipped from the seller fulfillment center to the buyer fulfillment center for a “last mile” from the buyer fulfillment center using a shipping carrier.

The seller item size and weight identifier 310 identifies physical dimensions of the item listed for sale by the seller by accessing historical data of the marketplace application 120. For example, the seller item size and weight identifier 310 can determine how big and how heavy an item is based on an identification of the item and the historical data. In another example, the seller may provide dimensions and weight of the item. In another embodiment, the seller item size and weight identifier 310 identifies physical dimensions of a package containing the item listed for sale by the seller using historical data of the marketplace application 120. For example, the seller item size and weight identifier 310 can determine or estimate common or typical physical dimensions of a package used to ship the item based on an identification of the item and the historical data.

In one embodiment, the seller item size and weight identifier 310 determines whether the item or package is eligible to be shipped using the containers of the fulfillment center. For example, a variety of shipping container or pallet sizes may be available. The seller item size and weight identifier 310 may determine that an item may be too big for any sizes of the containers and may not offer the container shipping program to the seller. In other words, the seller may not ship the item to any fulfillment center for holding because the item may too large, bulky, or have an odd shape.

The container shipping determination module 312 identifies a container having a prescheduled shipping route from the seller fulfillment center to the buyer fulfillment center. Prescheduled shipping routes may be established for the network of fulfillment centers. For example, there may be several containers leaving from fulfillment center A to fulfillment center B each day. The containers may leave on a regular interval or have preset schedules. For example, a container may leave at 6 am, 10 am, 2 pm, and 6 pm each day. The preset schedule may also vary based on the date. For example, there may be more containers shipped between the fulfillment center around holidays and less during the weekend. The number of containers and the prescheduled shipping routes may also depend on popular shipping routes. For example, there may be more items for shipping between fulfillment centers between geographic region A and geographic region B than between geographic region A and geographic region C. As such, there may be more containers in transit between geographic region A and geographic region B than between geographic region A and geographic region C.

The container shipping determination module 312 may further determine space availability in the container when the buyer views the item in the online marketplace. For example, when the buyer views the item, the container shipping determination module 312 determines how much physical space is available in a container that is leaving next with a shipping route between an identified fulfillment center associated with the seller and an identified fulfillment center associated with the buyer, at the time the buyer is viewing the item in the online marketplace. For example, the buyer views the item at 1 pm. The next container associated with the buyer and the seller leaves at 3 pm and is almost filled up. The container shipping determination module 312 thus determines how much space is left in that container.

The container shipping determination module 312 further determines whether the container has available space to receive or accommodate the item based on an identification of the item and the space availability of the container. For example, a pallet may have different predefined compartment sizes (e.g., small, medium, large). Each predefined compartment size is predetermined. The container shipping determination module 312 may identify which compartment size is needed to receive the item based on the dimensions of the item or the package of the item. If the item fits in a large compartment and the container only has small compartments available, the container shipping determination module 312 may provide the buyer with the option to ship on the next container leaving the fulfillment center to obtain the shipping container discount. Similarly, if the item is deemed a small item, and only large compartments are available in the container, the container shipping determination module 312 may still offer the buyer the container shipping discount offer.

The container shipping determination module 312 computes a shipping discount offer based on the space availability of the container. For example, the discount offer may be a flat discount rate such as 10% off standard shipping or may dynamically vary based on the space availability of the container. For example, if there are a lot of spaces available, the container shipping determination module 312 may increase the shipping discount rate to incentivize the buyer to purchase the item.

The container shipping determination module 312 or the marketplace application 120 generates a notification to the buyer of the shipping discount offer valid for a limited amount of time after the buyer views the item in the online marketplace. For example, the message to the buyer may include “order within the next 2 hours and get 10% off your shipping cost and the item ships today.” The limited amount of time may be based on a cut off shipping time of the prescheduled shipping route for the container. For example, if the buyer views the item at 3 pm and the cutoff time is 4:30 pm for the 5 pm shipping, the limited amount of time may be 1.5 hours.

In another embodiment, the limited amount of time may be computed based on the space availability of the container. For example, if there are a lot of spaces left in the container, the limited amount of time may be longer than when the container has very little available space left.

The item container allocation module 314 allocates a compartment space in the container if the buyer chooses to order with the shipping discount within the allotted limited amount of time. As such, after the order is placed from the buyer, the space availability of the container decreases according to the size of the item.

Once the container is received at the corresponding buyer fulfillment center, all individual orders would be shipped out to the last mile buyer location. By consolidated shipping in the middle “mile,” i.e., between the origin fulfillment center and the last mile fulfillment center, the shipping cost per package could be optimized (discounted) as a result of the consolidation or combining of shipments in a pallet/carton. Without consolidation, the shipping costs for each package would have no discount applied (e.g., standard shipping carrier charges).

Based on the historical data of the marketplace application 120, the system 102 is aware of which items can be shipped via pallets and which items cannot be shipped via pallets. At any given time of the day, the system 102 is systematically aware of how many pallets can be shipped from the warehouse/fulfillment center and how much space remains in those pallets. If an item/shipment is added to the pallet, then the available space in the pallets to be shipped out decreases and is immediately updated on the system 102. Pallets may ship out at set intervals during the day. In either case, with consolidation and without consolidation, the system 102 is able to provide accurate estimated delivery dates for package delivery.

The following is an example scenario:

There are few semi-filled cartons shipping from warehouse A (in the West coast) to warehouse B (in the East coast). A buyer from New York is browsing a particular item on the marketplace application 120. The shipping containerization application 122 is aware of whether the item can be shipped in a pallet and whether there is any available space in the pallets shipping out by end of day to the east coast warehouses. Based on the buyer's location, the specifics of the item, and the information that there are semi-filled cartons being sent to the buyer's region, the shipping containerization application 122 figures that the item can be packaged and housed in one of the shipping pallets. So the buyer receives a message in the shipping section which says, “Order within the next 2 hours and get X % off your shipping cost and the item ships today.” The message thus acts as an incentive and helps drive conversion for the particular item.

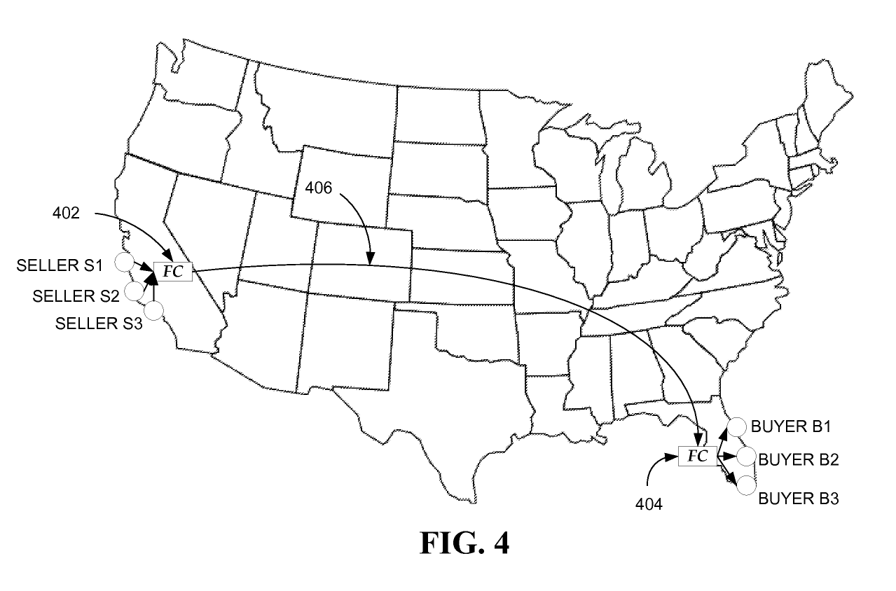

FIG. 4 shows a map diagram illustrating one example embodiment of a shipment using the shipment containerization application 122. A fulfillment center/warehouse 402 has a prescheduled shipping route 406 with fulfillment center/warehouse 404. Sellers S1, S2, and S3 ship their corresponding items for sale to their local fulfillment center/warehouse 402. Buyers B1, B2, and B3 place an order for the items for sale held at the local fulfillment center/warehouse 402. The items are shipped on the prescheduled shipping route 406 between the fulfillment center/warehouse 402 and the local fulfillment center/warehouse 404. The container or pallet remains secured between the fulfillment center/warehouse 402 and the local fulfillment center/warehouse 404. In other words, no items can be removed from the container during the prescheduled shipping route 406.

Once the container arrives at the fulfillment center/warehouse 404 associated with the buyers B1, B2, and B3, each item is removed from the container to be shipped out individually over the “last mile” to the buyer location. For example, the item may be delivered using a shipping carrier between the fulfillment center/warehouse 404 and the corresponding buyer location.

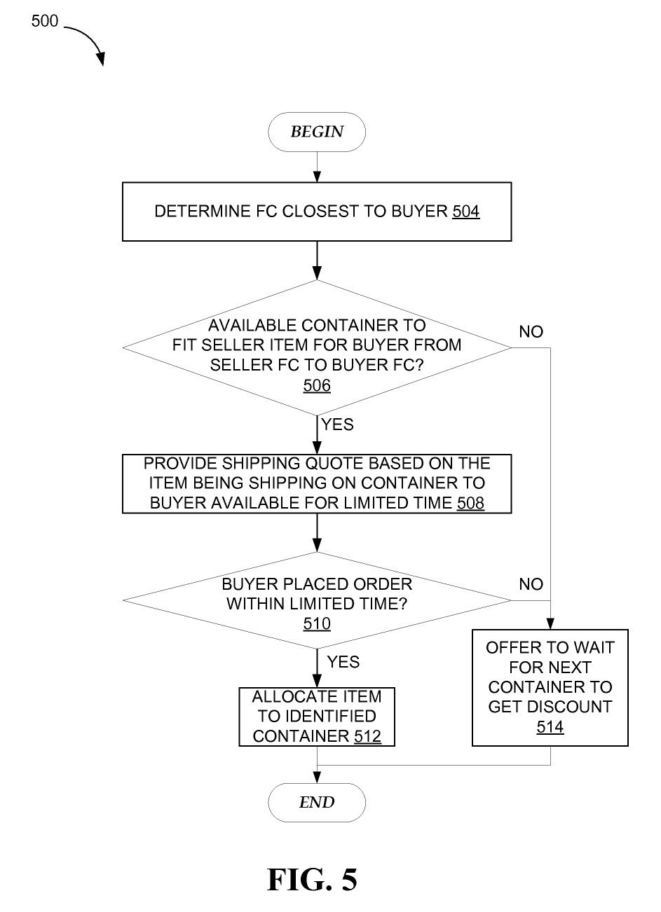

FIG. 5 shows a flow diagram illustrating one example embodiment of a method 500 of a shipment containerization application. At operation 504, the system determines the closest fulfillment center associated with the buyer of the marketplace application 120. At operation 506, the system determines whether the next container shipping out has available space to fit the item viewed by the buyer, where the containers have a prescheduled shipping route to the closest fulfillment center of the buyer.

At operation 510, if the next container does not have enough space to accommodate the item, the system may offer the buyer a shipping discount if the buyer places the order for the item before the following container leaves the warehouse.

At operation 508, if the next container has enough space to accommodate the item, the system may provide a shipping discount offer to the buyer. The offer may be valid for a limited amount of time. In other words, the buyer needs to place the order within the next x hours or minutes to qualify for the shipping discount offer.

At operation 512, if the buyer places the order within the limited amount of time, the system permanently decreases the amount of space available in the container.

At operation 514, if the buyer does not place the order within the limited amount of time, the system offers to wait for the next container so that the buyer may qualify for another discount. If the buyer does not want to wait for the next container, the buyer can proceed with standard shipping (e.g., individual shipping of the item using a shipping carrier).

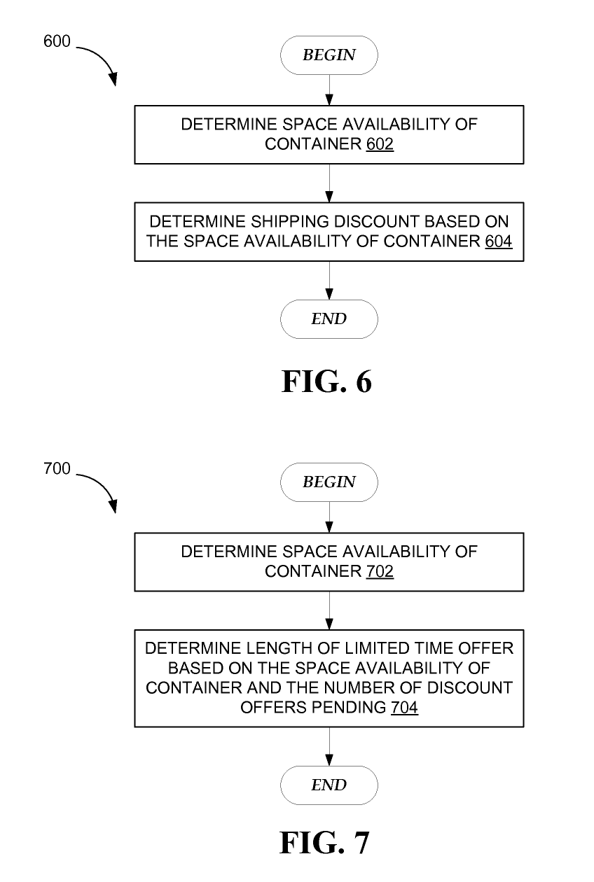

FIG. 6 shows a flow diagram illustrating one example embodiment of a method 600 for determining shipping discount based on space availability of a container. At operation 602, the space availability of a container is determined. At operation 604, the shipping discount is determined based on the space availability of the container.

FIG. 7 shows a flow diagram illustrating one example embodiment of a method 700 for determining a length of the limited time offer based on the number of discount offers pending. At operation 702, the system determines the space availability of a container. At operation 704, the length of the limited time offer is determined based on the space availability of the container and the number of discount offers pending to other current buyers associated with the same shipping route. For example, the system may determine that other offers to other buyers for the same container are pending.

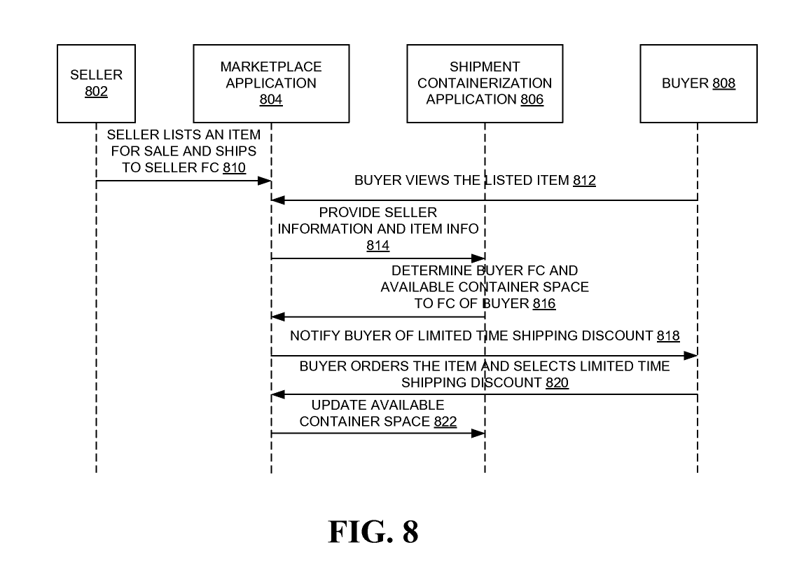

FIG. 8 shows a ladder diagram illustrating one example embodiment of an operation of a shipment containerization application. A seller 802 lists an item for sale via the marketplace application 804 and ships the item to a corresponding seller warehouse at operation 810. A buyer 808 views the listed item at operation 812. At operation 814, the shipment containerization application 806 accesses the marketplace application 804 to obtain seller information and item information. At operation 816, the shipment containerization application 806 determines whether the warehouse (also referred to as buyer warehouse) corresponding to the buyer 808 and whether a container to be shipped from the seller warehouse to the buyer warehouse has enough space to fit the item. At operation 818, if there is enough space, the marketplace application 804 notifies the buyer 808 of the limited time shipping discount offer. At operation 820, the buyer 808 orders the item within the limited amount of time and accepts the discount offer. At operation 822, the space available in the container is updated.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via network 104 (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, (e.g., a computer program tangibly embodied in an information carrier, e.g., in a machine-readable medium for execution by, or to control the operation of, data processing apparatus, e.g., a programmable processor, a computer, or multiple computers).

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware, may be a design choice. Below are set out hardware (e.g., machine) and software architectures that may be deployed in various example embodiments.

### Example Computer System

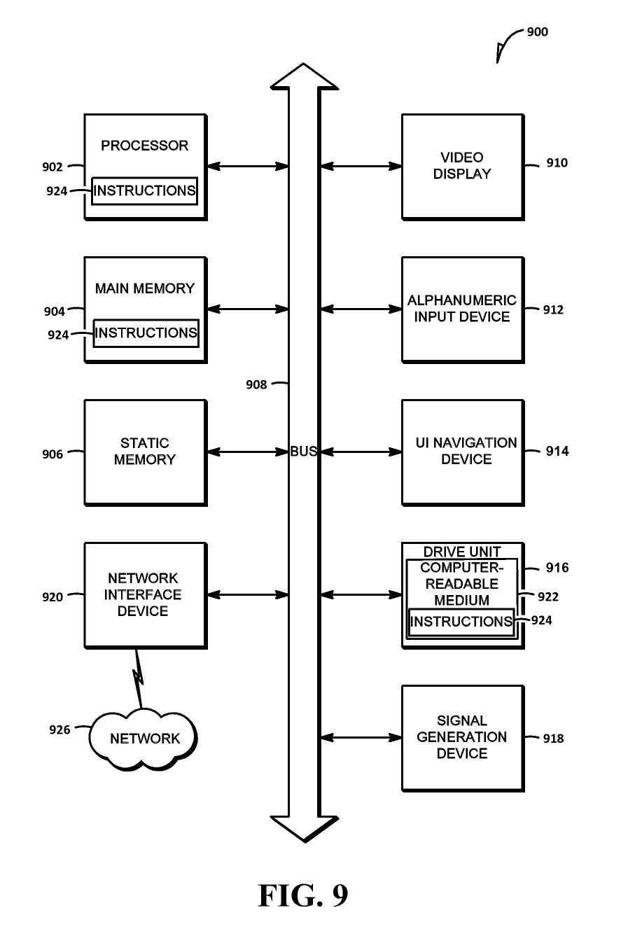

FIG. 9 shows a diagrammatic representation of a machine in the example form of a computer system 900 within which a set of instructions 924 may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine 110 or 112 in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions 924 (sequential or otherwise) that specify actions to be taken by that machine. Further, while only a single machine is illustrated, the term “machine” shall also be taken to include any collection of machines that individually or jointly execute a set (or multiple sets) of instructions 924 to perform any one or more of the methodologies discussed herein.

The example computer system 900 includes a processor 902 (e.g., a central processing unit (CPU), a graphics processing unit (GPU, or both)), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a UI navigation device 914 (e.g., a mouse), a disk drive unit 916, a signal generation device 918 (e.g., a speaker), and a network interface device 920.

The disk drive unit 916 includes a computer-readable medium 922 on which is stored one or more sets of data structures and instructions 924 (e.g., software) embodying or utilized by any one or more of the methodologies or functions described herein. The instructions 924 may also reside, completely or at least partially, within the main memory 904 and/or within the processor 902 during execution thereof by the computer system 900, with the main memory 904 and the processor 902 also constituting machine-readable media.

The instructions 924 may further be transmitted or received over a network 926 via the network interface device 920 utilizing any one of a number of well-known transfer protocols (e.g., HTTP).

While the computer-readable medium 922 is shown in an example embodiment to be a single medium, the term “computer-readable medium” should be taken to include a single medium or multiple media (e.g., a centralized or distributed database, and/or associated caches and servers) that store the one or more sets of instructions 924. The term “computer-readable medium” shall also be taken to include any medium that is capable of storing, encoding, or carrying a set of instructions 924 for execution by the machine and that cause the machine to perform any one or more of the methodologies of the present disclosure, or that is capable of storing, encoding or carrying data structures utilized by or associated with such a set of instructions 924. The term “computer-readable medium” shall, accordingly, be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system comprising:
a buyer fulfillment center identifier configured to identify a buyer fulfillment center associated with a region of a delivery address of a buyer of an item listed in an online marketplace, the item physically held at a seller fulfillment center; and
a container shipping determination module executable by a processor configured to identify a container having a prescheduled shipping route from the seller fulfillment center to the buyer fulfillment center, to determine space availability in the container when the buyer views the item in the online marketplace, to determine whether the container can receive the item based on an identification of the item and the space availability of the container, to compute a shipping discount offer based on the space availability of the container, to notify the buyer of the shipping discount offer valid for a limited amount of time after the buyer views the item in the online marketplace, the limited amount of time computed based on the space availability of the container and a cut off shipping time of the prescheduled shipping route of the container.

2. The system of claim 1, wherein the container shipping determination module is configured to:
determine physical dimensions of a package for the item based on historical data of the online marketplace; and
determine whether the package can fit in the container based on the physical dimensions of the package and the space availability of the container.

3. The system of claim 2, wherein the container shipping determination module is configured to:
determine whether the item qualifies for shipping with the container based on the physical dimensions of the item retrieved from the historical data of the online marketplace.

4. The system of claim 1, wherein the container physically houses a plurality of items ordered on the online marketplace, the plurality of items held at the seller fulfillment center and scheduled to be shipped to the same region of the delivery address of the buyer of the item.

5. The system of claim 1, wherein an amount of the shipping discount offer decreases as the space availability of the container decreases, and wherein the limited amount of time decreases as the space availability of the container decreases.

6. The system of claim 1, wherein the container shipping determination module is configured to:
temporarily reduce the space availability of the container based on a size of the item during the limited amount of time after the shipping discount offer is provided to the buyer;
receive a communication from the buyer accepting the shipping discount offer within the limited amount of time after the shipping discount offer is provided to the buyer; and
permanently reduce the space availability of the container based on the size of the item in response to receiving the communication from the buyer accepting the shipping discount offer within the limited amount of time after the shipping discount offer is provided to the buyer.

7. The system of claim 1, wherein the container shipping determination module is configured to:
temporarily reduce the space availability of the container based on a size of the item during the limited amount of time after the shipping discount offer is provided to the buyer;
receive a communication from the buyer declining the shipping discount offer within the limited amount of time after the shipping discount offer is provided to the buyer; and
increase the space availability of the container in response to receiving the communication from the buyer declining the shipping discount offer within the limited amount of time after the shipping discount offer is provided to the buyer.

8. The system of claim 1, wherein the container shipping determination module is configured to:
temporarily reduce the space availability of the container based on a size of the item during the limited amount of time after the shipping discount offer is provided to the buyer; and
increase the space availability of the container after the limited amount of time has elapsed.

9. The system of claim 1, wherein the container shipping determination module is configured to:
dynamically update the space availability of the container based on other shipping discount offers provided to other buyers of items associated with the same buyer fulfillment center and seller fulfillment center.

10. The system of claim 1, wherein the container shipping determination module is configured to:
compute a second shipping discount offer based on the space availability of a second container being shipped to the seller fulfillment center from the buyer fulfillment center at a time after the container has shipped; and
provide the second shipping discount offer to the buyer for a second limited time, the second limited time computed based on the space availability of the second container and after the cut off shipping time of the container and before the cut off shipping time of the second container.

11. A method comprising:
identifying a buyer fulfillment center associated with a region of a delivery address of a buyer of an item listed in an online marketplace, the item physically held at a seller fulfillment center;
identifying a container having a prescheduled shipping route from the seller fulfillment center to the buyer fulfillment center;
determining a space availability in the container when the buyer views the item in the online marketplace;
determining whether the container can receive the item based on an identification of the item and the space availability of the container;
computing a shipping discount offer based on the space availability of the container; and
notifying the buyer of the shipping discount offer valid for a limited amount of time after the buyer views the item in the online marketplace, the limited amount of time computed based on the space availability of the container and a cut off shipping time of the prescheduled shipping route of the container.

12. The method of claim 11, further comprising:
determining physical dimensions of a package for the item based on historical data of the online marketplace; and
determining whether the package can fit in the container based on the physical dimensions of the package and the space availability of the container.

13. The method of claim 12, further comprising:
determining whether the item qualifies for shipping with the container based on the physical dimensions of the item retrieved from the historical data of the online marketplace.

14. The method of claim 11, wherein the container physically houses a plurality of items ordered on the online marketplace, the plurality of items held at the seller fulfillment center and scheduled to be shipped to the same region of the delivery address of the buyer of the item.

15. The method of claim 11, wherein an amount of the shipping discount offer decreases as the space availability of the container decreases, and wherein the limited amount of time decreases as the space availability of the container decreases.

16. The method of claim 11, further comprising:
temporarily reducing the space availability of the container based on a size of the item during the limited amount of time after the shipping discount offer is provided to the buyer;
receiving a communication from the buyer accepting the shipping discount offer within the limited amount of time after the shipping discount offer is provided to the buyer; and
permanently reducing the space availability of the container based on the size of the item in response to receiving the communication from the buyer accepting the shipping discount offer within the limited amount of time after the shipping discount offer is provided to the buyer.

17. The method of claim 11, further comprising:
temporarily reducing the space availability of the container based on a size of the item during the limited amount of time after the shipping discount offer is provided to the buyer;
receiving a communication from the buyer declining the shipping discount offer within the limited amount of time after the shipping discount offer is provided to the buyer; and
increasing the space availability of the container in response to receiving the communication from the buyer declining the shipping discount offer within the limited amount of time after the shipping discount offer is provided to the buyer.

18. The method of claim 11, further comprising:
dynamically updating the space availability of the container based on other shipping discount offers provided to other buyers of items associated with the same buyer fulfillment center and seller fulfillment center.

19. The method of claim 11, further comprising:
computing a second shipping discount offer based on the space availability of a second container being shipped to the seller fulfillment center from the buyer fulfillment center at a time after the container has shipped; and
providing the second shipping discount offer to the buyer for a second limited time, the second limited time computed based on the space availability of the second container and after the cut off shipping time of the container and before the cut off shipping time of the second container.

20. A non-transitory computer-readable storage medium storing a set of instructions that, when executed by a processor, cause the processor to perform operations, comprising:
identifying a buyer fulfillment center associated with a region of a delivery address of a buyer of an item listed in an online marketplace, the item physically held at a seller fulfillment center;
identifying a container having a prescheduled shipping route from the seller fulfillment center to the buyer fulfillment center;
determining a space availability in the container when the buyer views the item in the online marketplace;
determining whether the container can receive the item based on an identification of the item and the space availability of the container;
computing a shipping discount offer based on the space availability of the container; and
notifying the buyer of the shipping discount offer valid for a limited amount of time after the buyer views the item in the online marketplace, the limited amount of time computed based on the space availability of the container and a cut off shipping time of the prescheduled shipping route of the container.
